(19) United States
(12) Patent Application Publication
(10) Pub. No.: US 2014/0015910 A1
(43) Pub. Date: Jan. 16, 2014

(54) PRINTER AND PAPER TRANSPORT METHOD IN PRINTER

(71) Applicant: Hon Hai Precision Industry Co., Ltd., New Taipei (TW)

(72) Inventors: CHI-YU TSANG, New Taipei (TW); CHING-WEI CHEN, New Taipei (TW)

(73) Assignee: HON HAI PRECISION INDUSTRY CO., LTD., New Taipei (TW)

(21) Appl. No.: 13/893,325

(22) Filed: May 13, 2013

(30) Foreign Application Priority Data
Jul. 16, 2012 (TW) 101125490

(51) Int. Cl. B41J 13/24

(52) U.S. Cl. CPC B41J 13/24
USPC 347/104

(57) ABSTRACT

A printer includes a stationary platen with stationary ribs, a printing head, and a movable platen with ribs which are interposed with those of the stationary ribs. The stationary platen supports a printed paper. A printing head is arranged opposite to the stationary platen and prints on the printed paper being transported over or onto the stationary platen. During printing, the movable platen moves in the same direction as the printed paper being printed, to maintain the printed paper in a single orientation and at one standard distance in relation to the printing head, to ensure the same quality of printing on the last part of the printed paper as well as on the beginning part.

### BACKGROUND

The disclosure generally relates to an ink jet printer and a paper transport method in printer.

### Description of Related Art

A conventional ink jet printer includes medium platen for supporting a recording medium, such as a sheet of paper. The platen defines a plurality of grooves. When a printed paper is arranged over the groove, the printed paper is warped down in the vertical direction. The printed paper is deformed such that the printed paper falls into the groove. If the printed paper is warped, a distance between a nozzle of the printing head and the surface of the printed paper is changed, and there is a possibility that a recording defect may arise. There is a need for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an assembled view of a paper transport component of a printer in one embodiment.

FIG. 2 is an isometric exploded view of the paper transport component of FIG. 1.

FIG. 3 is a similar to FIG. 2, but viewed from another aspect.

FIG. 4 to FIG. 7 show lateral assembled views of the paper transport component in one embodiment showing a printed paper in different positions.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

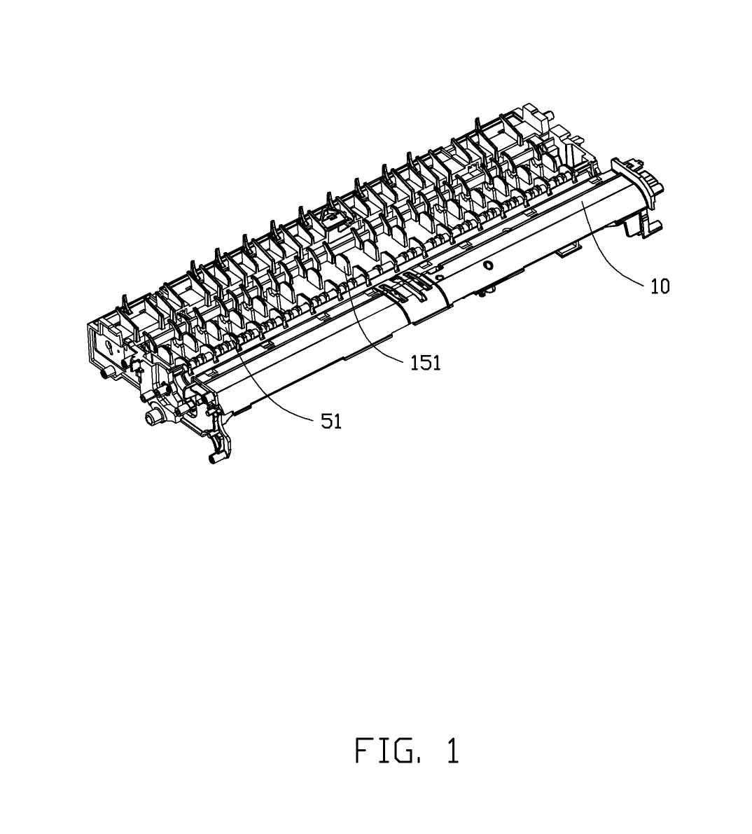

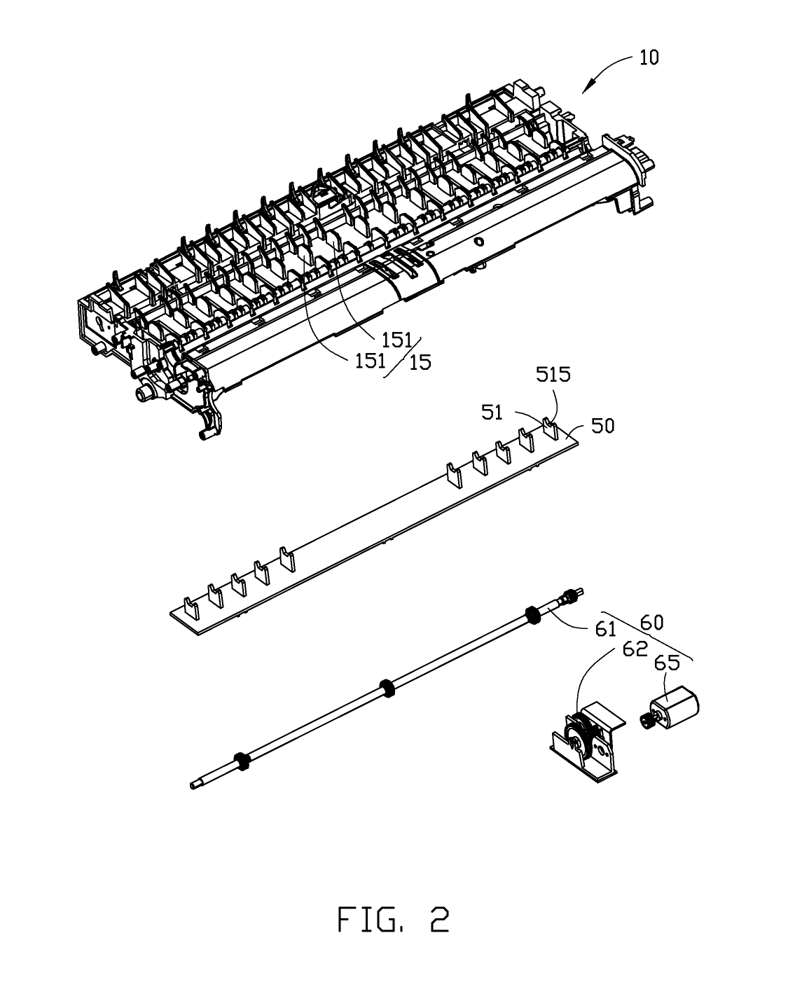

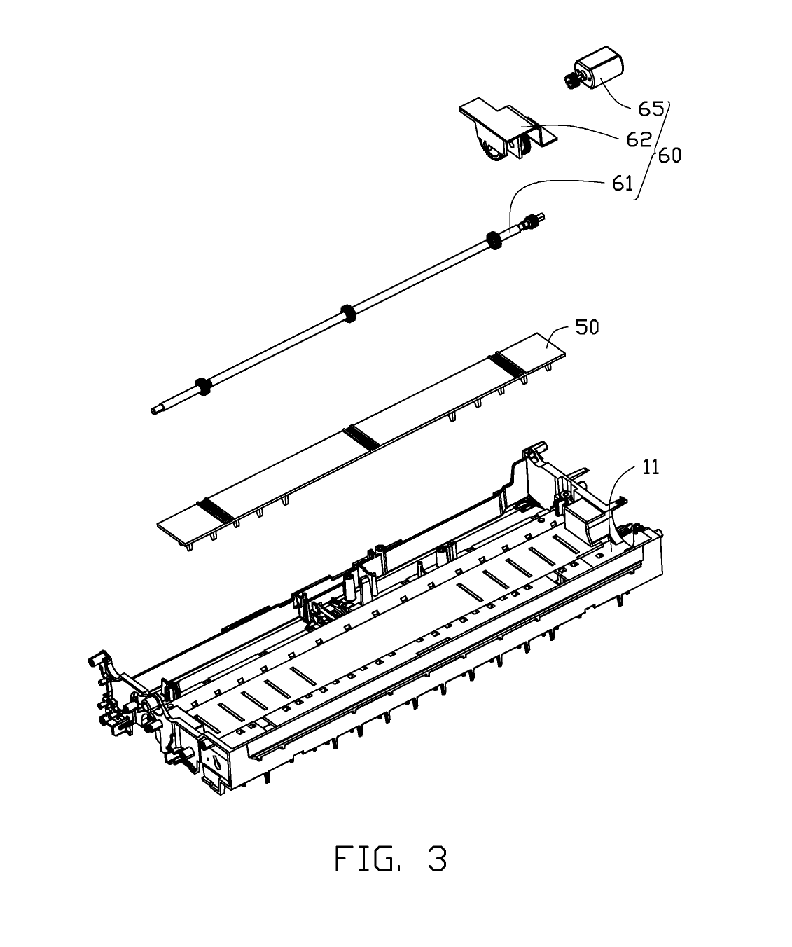

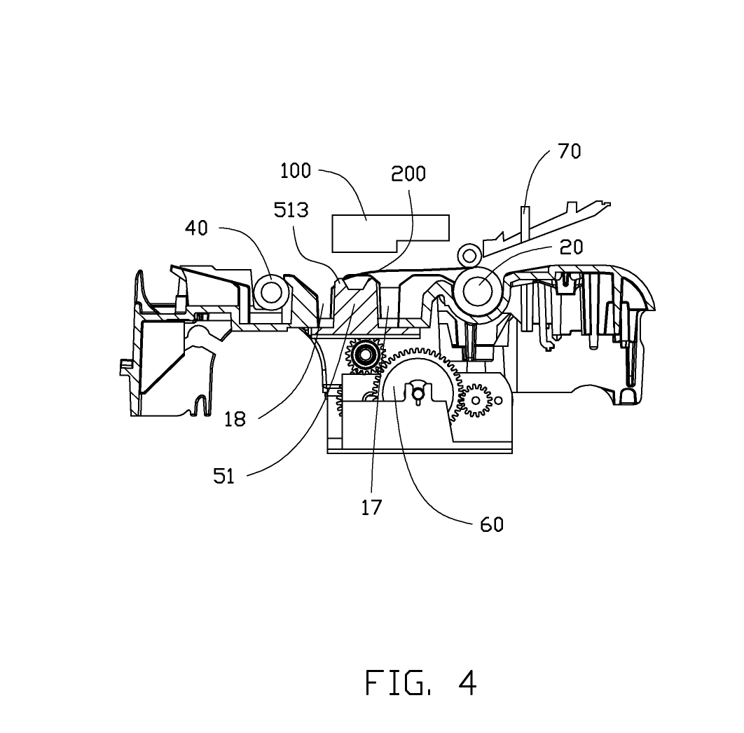

FIG. 1 to FIG. 4 illustrate one embodiment of a supporting component of an ink jet printer for supporting a printed paper 200. The supporting component includes an enclosure 10, a first guide rod 20, a second guide rod 40, a printing head 100, a movable platen 50, a driving device 60, and a paper detection device 70.

The enclosure 10 includes a base 11 and a stationary platen 15 on the base 11. The stationary platen 15 includes a plurality of stationary ribs 151. The plurality of stationary ribs 151 is aligned in a straight line. Each stationary rib 151 is sheet-like. The plurality of stationary ribs 151 is spaced and all the ribs are parallel. A first interval 17 and a second interval 18 are defined on opposite sides of the plurality of stationary ribs 151.

The movable platen 50 includes a plurality of movable ribs 51. The plurality of movable ribs 51 is aligned in a straight line. Each movable rib 51 is sheet-like. The plurality of movable ribs 151 is spaced and all the movable ribs are parallel. Each movable rib 51 includes two tabs 513. A peak of each tab 513 abuts the printed paper 200. The two tabs 513 are spaced from each other. The two tabs 513 have substantially the same height. A trapezoidal recess 515 is defined between the two tabs 513 on a rib 51. The movable platen 50 includes a plurality of teeth 56 at a bottom portion thereof.

The driving device 60 includes a driving pole 61, a gear set 62 and a motor 65. The motor 65 can drive the gear set 62 to rotate. The gear set 62 meshes with the teeth 56 of the movable platen 50 so as to driving the movable platen 50 to move.

The printing head 100 is arranged opposite the stationary platen 15. The printing head 100 prints an image on the printed paper 200 transported onto the stationary platen 15.

In assembly, the first guide rod 20, the second guide rod 40 are located on the enclosure 10. The printing head 100 is located on top of the plurality of stationary ribs 151. The movable platen 50 is slidably mounted to the base 11. The driving device 60 is mounted to the base 11 and meshes with the movable platen 50.

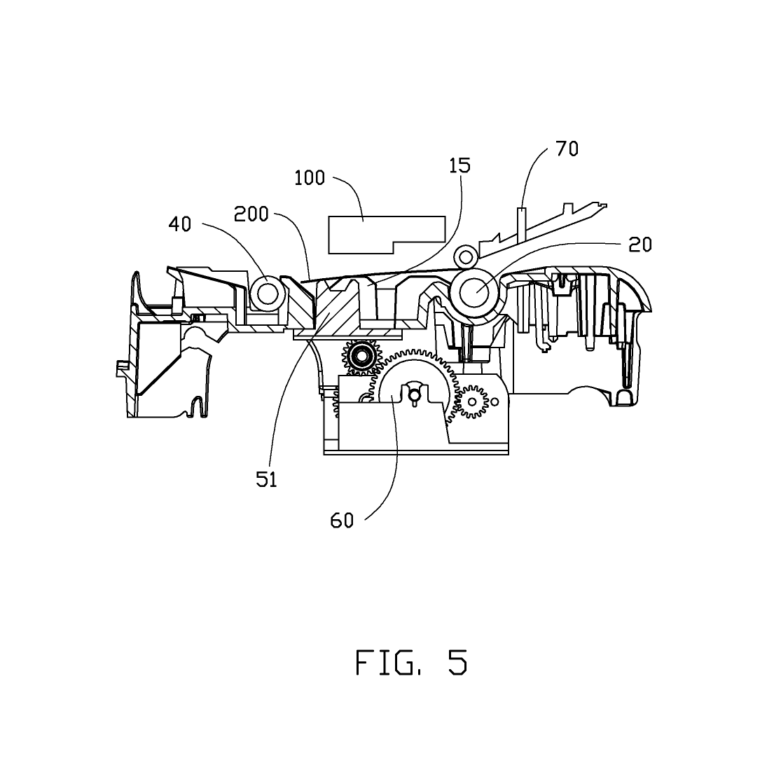

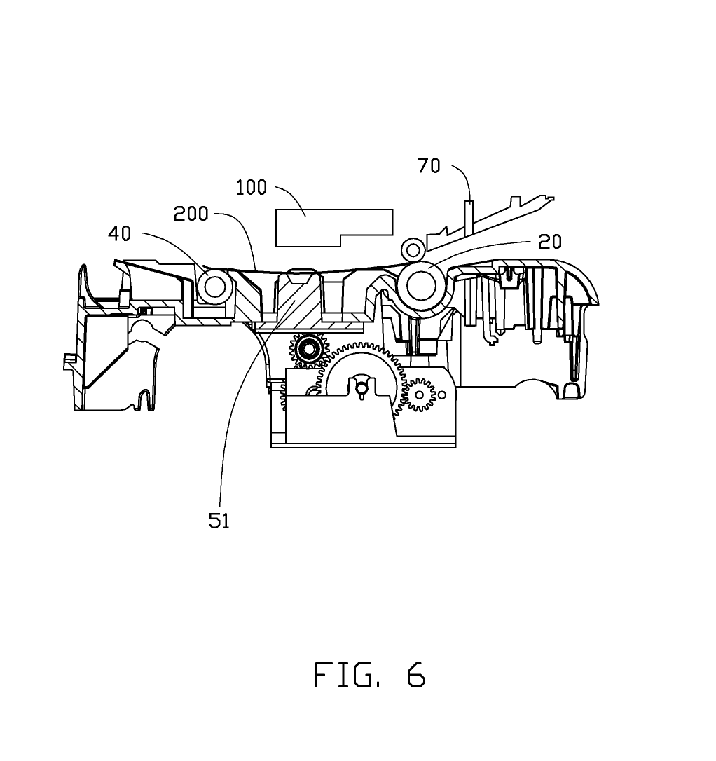

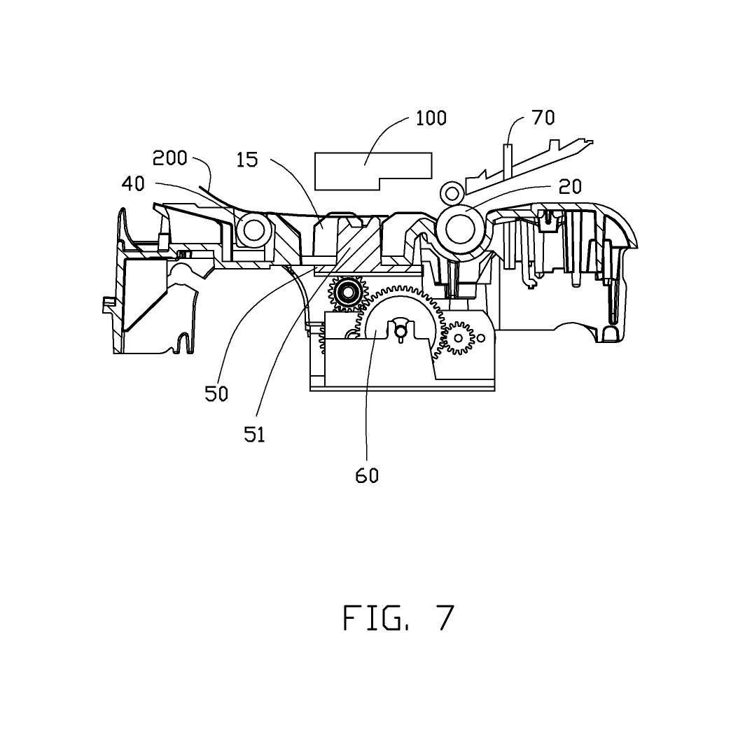

Referring to FIG. 5 to FIG. 7, in use, the printed paper 200 is fed in by the first guide rod 20. The movable platen 50 is located in a first position. In the first position, the plurality of movable ribs 51 is aligned with the plurality of stationary ribs 151. Each of the plurality of stationary ribs 151 alternates with a movable rib 51. The paper detection device 70 records an input time of the printed paper 200. When a front end of the printed paper 200 moves over the plurality of stationary ribs 151, the plurality of movable ribs 51 supports the front end of the printed paper 200 and the movable platen 50 is driven to move by the driving device 60 along the transport direction. The movable platen 50 stops in the second position in the second interval 18 and moves back when the printed paper 200 is moved to the second guide rod 40. In the second position, the plurality of movable ribs 51 is alternated with the plurality of the stationary ribs 151. When the paper detection device 70 detects a back end of the printed paper 200, the movable platen 50 moves to the first interval 17. The plurality of movable ribs 51 supports the back end of the printed paper 200 and moves with the printed paper 200.

A paper transport method includes the following steps.

Block s10: the first guide rod 20 guides in a printed paper 200. The paper detection device 70 detects a front end of the printed paper 200.

Block s12: the front end of the printed paper 200 is moved to a position between the print head 100 and the fix ribs 151. The plurality of stationary ribs 151 and the plurality of the movable ribs 51 support the front end of the printed paper 200.

Block s14: the driving device 60 drives the movable platen 50 to move with movement of the front end of the printed paper 200 until the front end of the printed paper 200 reaches the second guide rod 40.

Block s16: the movable platen 50 is driven to move to the first interval 17 from the second interval 18. The plurality of movable ribs 51 supports a back end of the printed paper 200 and moves in the transport direction following the printed paper 200.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A printer comprising:
a stationary platen for supporting a printed paper, and a plurality of stationary ribs located on the stationary platen;
a printing head which is arranged opposites to the stationary platen and which prints an image on the printed paper being transported onto the stationary platen along a transport direction; and
a movable platen which moves in the transport direction for supporting the printed paper while following the printed paper which is being transported to maintain the printed paper in a single orientation and at one standard distance in relation to the printing head, and the movable platen comprising a plurality of movable ribs,
wherein the movable platen is capable of moving from a first position to a second position; in the first position, the plurality of movable ribs is aligned and interposed with the plurality of stationary ribs; and in the second position, the plurality of movable ribs is staggered with the plurality of the stationary platen.

2. The printer of claim 1, wherein the transport direction is substantially straight.

3. The printer of claim 1, wherein the plurality of stationary ribs is spaced by the plurality of movable ribs in the first position.

4. The printer of claim 1, wherein each of the plurality of movable ribs comprises two tabs, and the two tabs have substantially same height.

5. The printer of claim 4, wherein each of the two tabs is spaced from each other, and a peak of each of the two tabs abuts the printed paper.

6. The printer of claim 4, wherein a trapezoidal recess is defined between the two tabs.

7. The printer of claim 1, further comprising a paper detection device for detecting an access of the printed paper.

8. A paper transport method in a printer comprising:
feeding a printed paper into a paper transporting path;
a plurality of stationary ribs and a plurality of movable ribs supporting a front end of the printed paper in an original position;
moving the plurality of movable ribs in a transport direction following the printed paper;
moving the plurality of movable ribs to support a back end of the printed paper; and
moving the plurality of movable ribs in the transport direction following the printed paper.

9. The paper transport method of claim 8, wherein the transport direction is substantially straight.

10. The paper transport method of claim 8, wherein the plurality of stationary ribs is interposed with the plurality of movable ribs in the original position.

11. The paper transport method of claim 8, wherein each of the plurality of movable ribs comprises two tabs, and the two tabs have substantially same height.

12. The paper transport method of claim 11, wherein each of the two tabs is spaced to each other, and a peak of each of the two tabs abuts the printed paper.

13. The paper transport method of claim 11, wherein a trapezoidal recess is defined between the two tabs.

14. The paper transport method of claim 8, further comprising a paper detection device for detecting an access of the printed paper.

15. A paper transport method in a printer comprising:
feeding a printed paper into a paper transporting path, a plurality of stationary ribs and a plurality of movable ribs supporting the printed paper, wherein the plurality of stationary ribs and the plurality of movable ribs are located between a first interval and a second interval;
moving the plurality of movable ribs from an original position to the second interval to support a first part of the printed paper to maintain the printed paper in the transporting path; and
moving the plurality of the movable ribs from the second interval to the first interval to support a second part of the printed paper to maintain the printed paper in the transporting path.

16. The paper transport method of claim 15, wherein the paper transporting path is substantially straight.

17. The paper transport method of claim 15, wherein the plurality of stationary ribs is interposed with the plurality of movable ribs in the original position.

18. The paper transport method of claim 15, wherein each of the plurality of movable ribs comprises two tabs, and the two tabs have substantially same height.

19. The paper transport method of claim 18, wherein each of the two tabs is spaced to each other, and a peak of each of the two tabs abuts the printed paper.

20. The paper transport method of claim 15, wherein a trapezoidal recess is defined between the two tabs.
